(19) United States
(12) Patent Application Publication
(10) Pub. No.: US 2019/0305583 A1
(43) Pub. Date: Oct. 3, 2019

(54) ENERGY HARVEST TERMINAL

(71) Applicant: PANASONIC INTELLECTUAL PROPERTY MANAGEMENT CO., LTD., Osaka (JP)

(72) Inventors: Yuki TANAKA, Tokyo (JP); Ryosuke HASABA, Kanagawa (JP); Yoshio KOYANAGI, Kanagawa (JP); Kazuki KANAI, Kanagawa (JP)

(21) Appl. No.: 16/366,104

(22) Filed: Mar. 27, 2019

(30) Foreign Application Priority Data
Mar. 30, 2018 (JP) 2018-068036

(51) Int. Cl. H02J 7/34; G05F 1/67; H02M 3/04; H02J 7/00

(52) U.S. Cl. CPC H02J 7/345; H02J 7/0068; H02M 3/04; G05F 1/67

(57) ABSTRACT

An energy harvest terminal includes a distribution circuit that distributes input radio wave power to at least two branch paths, a main rectification circuit that converts first radio wave power supplied to one of the at least two branch paths from the distribution circuit into DC output power, a DC-DC converter that performs voltage conversion on the DC output power of the main rectification circuit, a sub-rectification circuit that converts second radio wave power supplied to another of the at least two branch paths from the distribution circuit into DC output power, and an electricity storage device connected to an output of the DC-DC converter. The DC-DC converter performs a feedback control for equalizing an output voltage of the main rectification circuit and an output voltage of the sub-rectification circuit.

### CROSS REFERENCE TO RELATED APPLICATIONS

This application is based on Japanese Patent Application (No. 2018-068036) filed on Mar. 30, 2018, the contents of which are incorporated herein by reference.

### BACKGROUND OF THE INVENTION

### 1. Field of the Invention

The present disclosure relates to an energy harvest terminal.

### 2. Description of the Related Art

At present, in sensor terminals employed in a wireless sensor network, a primary battery such as a button battery, a solar cell, a thermoelectric conversion element, or the like is used as a power source. However, primary batteries need to be replaced and solar cells and thermoelectric conversion elements are high in material cost. Such problems relating to the power source are obstacles to the spread of wireless sensor networks.

Where RFID (Radio-Frequency Identification) is used as a communication system, sensor terminals do not transmit communication radio waves spontaneously and hence are low in power consumption. As such, sensor terminals can utilize energy harvesting to obtain power. Energy harvesting is a technology for acquiring power from ambient energy and is applied preferably to low power consumption devices such as sensor terminals being discussed. Among energy harvesting techniques are ones that utilize light, thermoelectricity, vibration, electromagnetic waves, or the like. Energy harvesting utilizing electromagnetic waves uses radio wave power as all or part of power used and thus enables a wireless sensor terminal that does not require replacement of a battery.

In general, energy harvest terminals that are supplied with power wirelessly are equipped with an RF-DC conversion circuit for converting radio waves into a DC voltage. The efficiency of the RF-DC conversion circuit depends on its output voltage Vₒᵤₜ and its maximum efficiency output voltage V_{outPmax} varies depending on the input power Pᵢₙ. Thus, in wireless power transfer in which the input power may vary to a large extent, it is important to maintain a relationship Vₒᵤₜ=V_{outPmax} in real time. What is called MPPT (maximum power point tracking) is a technique for maximizing such conversion efficiency.

JP-B-5921447 provides an energy harvesting system for transferring energy from an energy harvester having an output impedance to a DC-DC converter. A maximum power point tracking (MPPT) circuit includes a replica impedance that is a multiple of the harvester output impedance. The MPPT circuit enables maximum power point tracking between the harvester and the DC-DC converter by applying the same voltage as an output voltage of the harvester to the replica impedance and generating a feedback current that is equal to a multiple-divided input current received from the harvester.

JP-A-2014-217250 provides a thermoelectric power generation device capable of extracting a maximum output power from a thermoelectric power generation element by a simple circuit. The thermoelectric power generation device includes a thermoelectric power generation element, an operating point setting circuit which is connected to the thermoelectric power generation element and sets an operating point on the basis of an output of the thermoelectric power generation element that is obtained with each prescribed piece of timing, a sequence circuit which is connected to the operating point setting circuit and supplies a sample/hold signal to it, a DC-DC converter which is connected to the operating point setting circuit and generates an output voltage, and an error amplifier which is connected to the output of the DC-DC converter and feeds back a feedback signal to the DC-DC converter.

However, the techniques disclosed in JP-B-5921447 and JP-A-2014-217250 are not necessarily suitable for energy harvest terminals. For example, in JP-B-5921447, since the input impedance is kept constant by causing a current to flow through the replica impedance, the power that is consumed by the replica impedance cannot be made zero and hence it is difficult to attain low power consumption. Furthermore, since input and output voltages of an operational amplifier become equal to an input power supply voltage, a rail-to-rail operational amplifier is necessary, resulting in increase in the number of transistors. Still furthermore, since the replica impedance has a large resistance value, a large area is necessary when it is implemented in an integrated circuit.

In JP-A-2014-217250, since sample-and-holding is performed discontinuously, a time lag occurs in following an input that varies in real time, resulting in a power loss. Since power cannot be supplied while sample-and-holding is performed, the power efficiency lowers if the sampling interval is set short. Furthermore, an open-circuit voltage is sampled every prescribed time, it is necessary to provide a pass transistor between the input and the DC-DC converter, possibly resulting in a power loss.

### SUMMARY

An object of the present disclosure is to provide an energy harvest terminal that is superior in power conversion efficiency.

The disclosure provides an energy harvest terminal including a distribution circuit that distributes input radio wave power to at least two branch paths, a main rectification circuit that converts first radio wave power supplied to one of the at least two branch paths from the distribution circuit into DC output power, a DC-DC converter that performs voltage conversion on the DC output power of the main rectification circuit, a sub-rectification circuit that converts second radio wave power supplied to another of the at least two branch paths from the distribution circuit into DC output power, and an electricity storage device connected to an output of the DC-DC converter, wherein the DC-DC converter performs a feedback control for equalizing an output voltage of the main rectification circuit and an output voltage of the sub-rectification circuit.

The disclosure makes it possible to maximize the power conversion efficiency irrespective of the input power by performing a feedback control for equalizing the output voltages of the main rectification circuit and the sub-rectification circuit.

### BRIEF DESCRIPTION OF THE DRAWINGS

FIG. 1 is a block diagram of an energy harvest terminal according to an embodiment of the present disclosure.

FIG. 2 is a three-dimensional graph as a visualization of power conversion efficiency (energy conversion efficiency) of an RF-DC conversion circuit.

FIG. 3 is a block diagram of part of the energy harvest terminal according to the embodiment.

FIGS. 4A to 4C are graphs showing voltage-power conversion efficiency characteristics of a main rectification circuit and a sub-rectification circuit shown in FIG. 3; more specifically, FIG. 4A is a graph of case that the input power is equal to −4 dBm, FIG. 4B is a graph of case that the input power is equal to −9 dBm, and FIG. 4C is a graph of case that the input power is equal to −13 dBm.

FIG. 5 is a block diagram of part of an energy harvest terminal according to another embodiment.

FIGS. 6A to 6C are graphs showing voltage-power conversion efficiency characteristics of a main rectification circuit and a sub-rectification circuit shown in FIG. 5; more specifically, FIG. 6A is a graph of case that the input power is equal to −10 dBm, FIG. 6B is a graph of case that the input power is equal to −5 dBm, and FIG. 6C is a graph of case that the input power is equal to −3 dBm.

FIGS. 7A to 7C show example distribution circuits; more specifically, FIGS. 7A and 7B show example distribution circuits using lumped constant circuits and FIG. 7C shows an example distribution circuit using distributed constant circuits.

### DETAILED DESCRIPTION OF THE EXEMPLARY EMBODIMENTS

An energy harvest terminal according to each specific embodiment of the present disclosure will be hereinafter described in detail by referring to the drawings when necessary. However, unnecessarily detailed descriptions may be omitted. For example, detailed descriptions of well-known items and duplicated descriptions of constituent elements having substantially the same ones already described may be omitted. This is to prevent the following description from becoming unnecessarily redundant and thereby facilitate understanding of those skilled in the art.

The following description and the accompanying drawings are provided to allow those skilled in the art to understand the disclosure sufficiently and are not intended to restrict the subject matter set forth in the claims.

An energy harvest terminal 100 according to a preferred embodiment of the disclosure will be hereinafter described in detail with reference to the drawings.

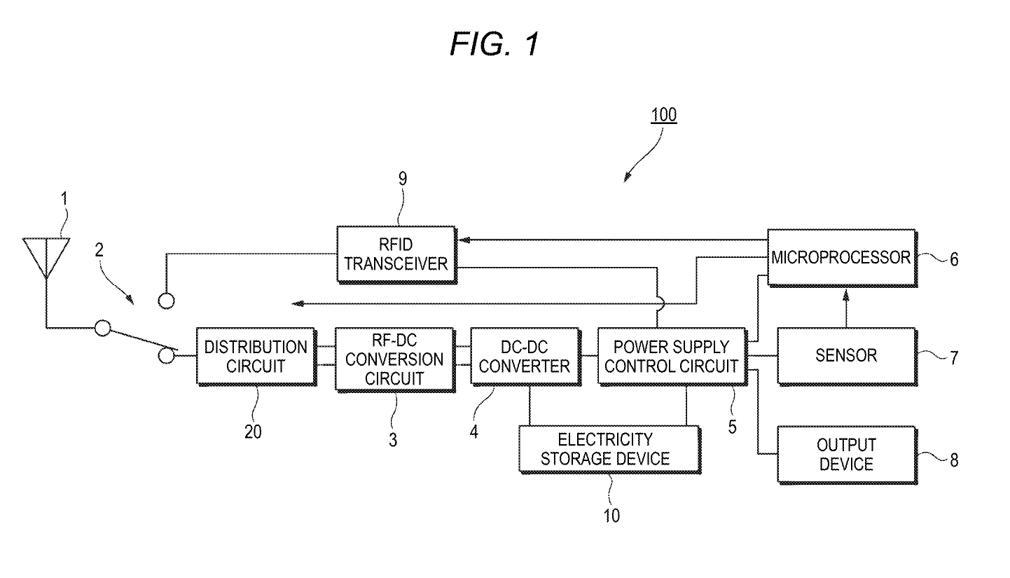

FIG. 1 is a block diagram of the energy harvest terminal 100 according to the embodiment of the disclosure. The energy harvest terminal 100 includes an antenna 1, a radio-frequency switch 2, an RF-DC (radio frequency-direct current) conversion circuit 3, a DC-DC converter 4, a power supply control circuit 5, a microprocessor 6, a sensor 7, an RFID transceiver 9, an electricity storage device 10, and a distribution circuit 20.

Utilizing electromagnetic wave energy harvesting, the energy harvest terminal 100 is activated by receiving power through radio waves by wireless communication from an external RFID communication node such as an RFID reader/writer (power supply technique). Whereas there are no particular limitations on the application fields of the energy harvest terminal 100, it is implemented as any of various kinds of electronic devices, chips, etc., and is expected to be used as, for example, a terminal for realizing what is called IoT (Internet of Things) in which various kinds of things are connected to communication networks such as the Internet and controlled by each other by causing information exchange between them. It is assumed that the energy harvest terminal 100 is installed in various kinds of places such as various infrastructures such as factories, houses, nursing facilities, and roads, and human bodies. Since the energy harvest terminal 100 according to the embodiment can be driven being supplied with power externally and does not require an independent power source, it is relatively easy to install a very large number of energy harvest terminals 100 in a vast variety of places.

The antenna 1 plays a role of a power supply antenna for receiving power by receiving radio waves (radio wave power) having a prescribed frequency (e.g., a microwave frequency such as 920 MHz) from an external RFID node. The antenna 1 also plays a role of an information communication antenna because it can transmit a value (i.e., information data) acquired by the sensor 7 (described later) to an external RFID communication node and receive information data from this RFID communication node, cooperating with the RFID transceiver 9 which is a wireless transceiver. There are no particular limitations on the kind of the antenna 1; it may an antenna having any of various kinds of structures such as a patch antenna and a slot antenna.

The radio-frequency switch 2 is a device for switching between the functions of the antenna 1. When the antenna 1 functions as a power supply antenna, the radio-frequency switch 2 connects the antenna 1 to the RF-DC conversion circuit 3 via the distribution circuit 20 and supplies received radio wave power to the RF-DC conversion circuit 3. On the other hand, when the antenna 1 functions as an information communication antenna, the radio-frequency switch 2 connects antenna 1 to the RFID transceiver 9 to enable exchange of information data with an external RFID communication node.

The RF-DC conversion circuit 3 converts an AC current corresponding to radio wave power received by the antenna 1 into a DC current and outputs the latter. The DC-DC converter 4 converts the output of the RF-DC conversion circuit 3 into a prescribed voltage that is suitable for various downstream loads (power supply control circuit 5, electricity storage device 10, etc.) by varying its impedance. The power supply control circuit 5 controls power to be supplied to the microprocessor 6, the sensor 7, the output device 8, and the electricity storage device 10. The details of the RF-DC conversion circuit 3, the DC-DC converter 4, and the distribution circuit 20 will be described later.

The microprocessor 6 is a microcontroller for controlling the overall operation of the energy harvest terminal 100. Activated by an activation trigger signal, the microprocessor 6 controls the radio-frequency switch 2 and the RFID transceiver 9 while sending a power control signal for suppression of power consumption. The microprocessor 6 acquires detection data from the sensor 7 through a communication signal, performs prescribed calculation, and writes resulting calculation data to the RFID transceiver 9.

The sensor 7 is provided according to a particular parameter of an external environment to be detected by the energy harvest terminal 100 and is a load whose activation requires supply of power. The sensor 7 is a temperature sensor when the particular parameter of the external environment is temperature and is a pressure sensor when the particular parameter is pressure; there are no particular limitations on its type. The single energy harvest terminal 100 can be equipped with plural sensors 7. The sensor 7 detects a value from the external environment and supplies it to the microprocessor 6.

The output device 8, which is, for example, a small display, outputs (displays) various kinds of information such as an electricity storage state of the energy harvest terminal 100 under the control of the power supply control circuit 5. There are no particular limitations on the kind of the output device 8, and the output device 8 is not indispensable to the energy harvest terminal 100. The electricity storage device 10, which is, for example, a capacitor, functions as a power source (battery) of the energy harvest terminal 100.

It is known that the power conversion efficiency of the RF-DC conversion circuit 3 which converts radio waves into a DC current depends on its output voltage Vₒᵤₜ and its maximum efficiency output voltage V_{outPmax} varies depending on the input power Pᵢₙ. Thus, in wireless power transfer in which the input power may vary to a large extent, it is important to maintain a relationship Vₒᵤₜ=V_{outPmax} in real time. What is called MPPT (maximum power point tracking) is a technique for maximizing such conversion efficiency.

In general, MPPT is a technique for maximizing the output power Pₒᵤₜ of an RF-DC conversion circuit by varying its output current Iₒᵤₜ or output voltage Vₒᵤₜ while monitoring the output power Pₒᵤₜ (Pₒᵤₜ=Iₒᵤₜ×Vₒᵤₜ) using an A/D converter and a computing device. However, this technique is associated with drawbacks of a high power consumption and a large circuit scale because it is necessary to cause the A/D converter and the computing device to operate in real time.

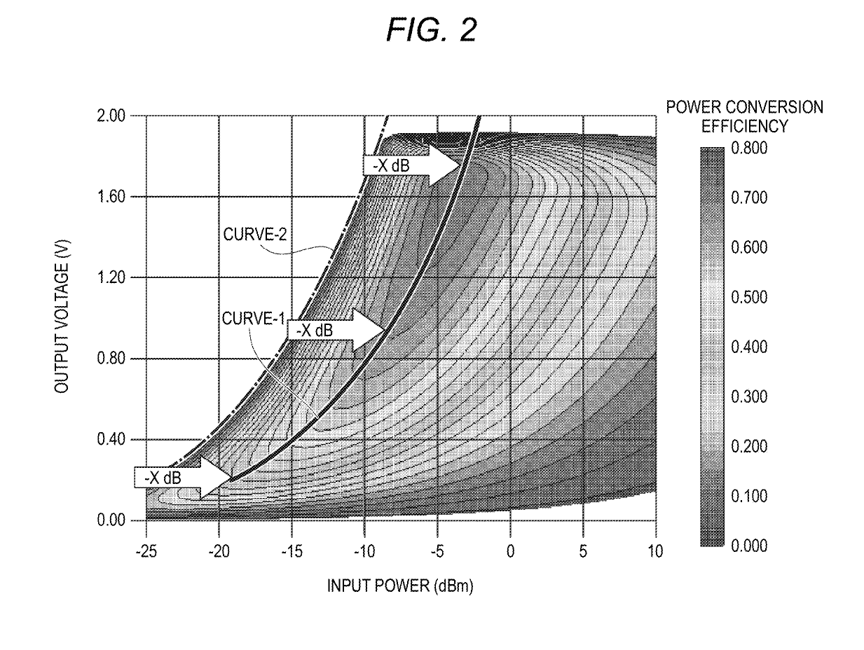

FIG. 2 is a three-dimensional graph as a visualization of power conversion efficiency (energy conversion efficiency) of the RF-DC conversion circuit 3 which converts radio waves into a DC current. The horizontal axis (x axis) represents the input power (dBm), that is, the radio wave power received by the antenna 1 and the vertical axis (y axis) represents the output voltage (V) of the RF-DC conversion circuit 3. The power conversion efficiency of the RF-DC conversion circuit 3 corresponding to the input power (on the horizontal axis) and the output voltage (on the vertical axis) is represented by contour lines (on the z axis perpendicular to the paper surface of FIG. 2). Curve-1 which is a ridge line of the contour lines is a maximum conversion efficiency curve that is a collection of points at each of which the power conversion efficiency becomes highest for a certain input power, that is, a collection of combinations of an optimum input power and output voltage. Highest power conversion efficiency is obtained by driving the RF-DC conversion circuit 3 on this curve. On the other hand, a leftmost curve-2 is an open-circuit voltage curve that is a collection of points where the output current obtained is equal to 0 though the voltage is high, that is, points where the output voltage of the RF-DC conversion circuit 3 becomes an open-circuit voltage and the efficiency is equal to zero theoretically.

The inventors studied the characteristics of the RF-DC conversion circuit 3, in particular, the relationship between the open-circuit voltage and the maximum efficiency voltage, by referring to the graph of FIG. 2. As a result, the inventors have found that in FIG. 2 the open-circuit voltage curve moves and coincides with the maximum conversion efficiency curve when the input power is shifted by a prescribed value X dB, that is, multiplied by a prescribed magnification (because the horizontal axis is in a logarithmic scale). It is seen that on the graph of FIG. 2 curve-2 comes to coincide with curve-1 when translated rightward and the prescribed value X is constant irrespective of the input power value (on the horizontal axis). The prescribed value X takes various values due to various factors such as the configuration of the circuit and the characteristics of devices used. In the example of FIG. 2, the prescribed value X is equal to 6 dB (−6 dB).

The above finding indicates that even if the input power has varied, it is possible to cause the RF-DC conversion circuit 3 to operate on the maximum conversion efficiency curve on the basis of an open-circuit voltage of the RF-DC conversion circuit 3 corresponding to a −6 dB shift of the input power if that open-circuit voltage is obtained. To explain how such an operation is realized, the energy harvest terminal 100 according to the embodiment will be described in detail together with the details of the RF-DC conversion circuit 3 and the DC-DC converter 4.

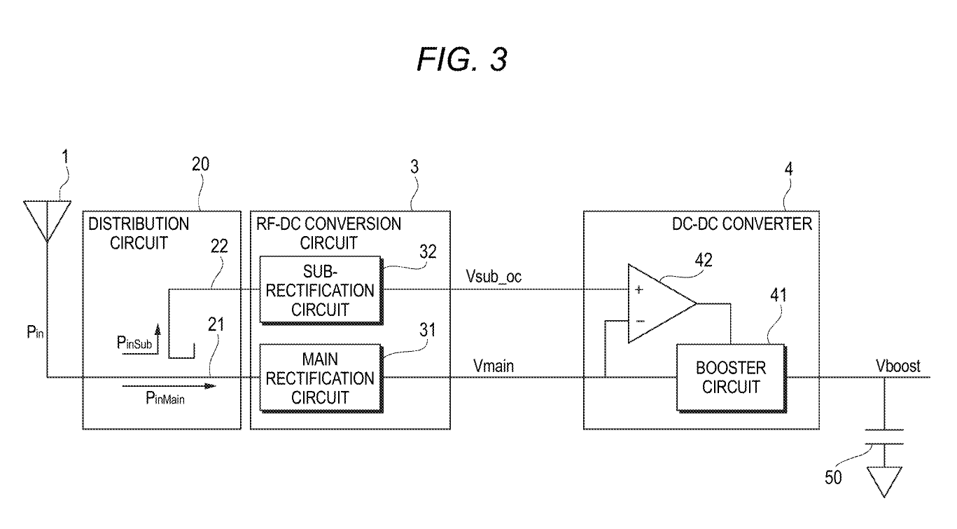

FIG. 3 is a block diagram of part of the energy harvest terminal 100 according to the embodiment. In the embodiment, the distribution circuit 20 is provided between the antenna 1 and the RF-DC conversion circuit 3. The RF-DC conversion circuit 3 has a main rectification circuit 31 and a sub-rectification circuit 32, and the DC-DC converter 4 has a booster circuit 41 and an error amplifier 42. The output of the booster circuit 41 is connected to an electricity storage device (capacitor) 50, which is grounded.

The distribution circuit 20 is a circuit for distributing an input radio-frequency power Pᵢₙ corresponding radio wave power received by the antenna 1 to at least two branch paths, that is, a main path 21 and a subpath 22. Main power P_{inMain} for driving the energy harvest terminal 100 is supplied to the main path 21, and subpower P_{inSub} for performing a control of this disclosure is supplied to the subpath 22. Naturally, the main power P_{inMain} is higher than the subpower P_{inSub} (P_{inMain}>P_{inSub}). The distribution circuit 20 distributes power at, for example, a ratio of P_{inMain}:P_{inSub}=8:2; the ratio is determined as appropriate according to the characteristics of the energy harvest terminal 100 and the environment.

The RF-DC conversion circuit 3 has the main rectification circuit 31 and the sub-rectification circuit 32 which are connected to the main path 21 and the subpath 22 of the distribution circuit 20, respectively. The main rectification circuit 31 converts the one input radio-frequency power supplied from the distribution circuit 20 into DC output power. The sub-rectification circuit 32 converts the other input radio-frequency power supplied from the distribution circuit 20 into DC output power. Where the distribution circuit 20 distributes power to the two paths at, for example, a ratio (1−β):β, P_{inMain}=(1−β)Pᵢₙ is supplied to the main rectification circuit 31 and P_{insub}=βPᵢₙ is supplied to the sub-rectification circuit 32.

The DC-DC converter 4 converts an output voltage of the RF-DC conversion circuit 3 into a prescribed voltage that is suitable for the various downstream loads (power supply control circuit 5, electricity storage device 10, etc.) by performing, by varying its impedance, voltage conversion on the output power of the main rectification circuit 31 received. In the embodiment, the DC-DC converter 4 has the booster circuit 41 and the error amplifier 42. The booster circuit 41, which plays a main role of the DC-DC converter 4, receives an output voltage Vₘₐᵢₙ of the main rectification circuit 31 as well as an output of the error amplifier 42. The output voltage Vₘₐᵢₙ of the main rectification circuit 31 is input to the minus terminal of the error amplifier 42 and an output voltage V_{sub_oc} of the sub-rectification circuit 32 is input to the plus terminal of the error amplifier 42. The booster circuit 41 increases its input impedance as the output of the error amplifier 42 increases and decreases its input impedance as the output of the error amplifier 42 decreases and increases, respectively. As such, the booster circuit 41 serves as part of a feedback control system and is controlled so that a relationship V_{Main}=V_{sub_oc} is established finally.

The electricity storage device 50 which is connected to the output of the DC-DC converter 4 plays a role of smoothing an output voltage V_{boost} of the DC-DC converter 4. Being a booster-type converter, the DC-DC converter 4 has a relatively large output impedance. Thus, provided with the electricity storage device 50, the DC-DC converter 4 can supply a stable voltage to loads such as a microcontroller and a sensor whose impedances vary over time.

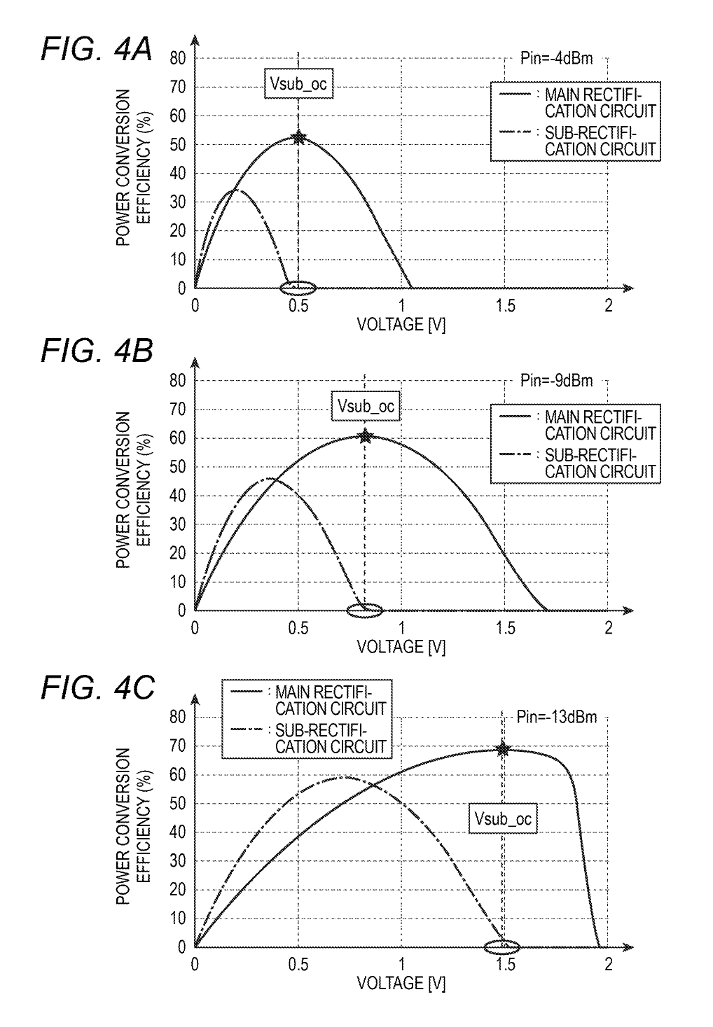

FIGS. 4A-4C are graphs showing voltage-power conversion efficiency characteristics (i.e., characteristics of the power conversion efficiency vs. the input voltage) of the main rectification circuit 31 and the sub-rectification circuit 32 shown in FIG. 3. FIGS. 4A-4C are graphs of cases that the input power Pᵢₙ is equal to −4 dBm, −9 dBm, and −13 dBm, respectively. The horizontal axis (x axis) corresponds to the input radio-frequency power and the vertical axis (y axis) represents the power conversion efficiency.

In the embodiment, input radio-frequency power is distributed to the two paths, that is, the main path 21 and the subpath 22, so that the output open-circuit voltage of the sub-rectification circuit 32 becomes equal to a voltage at which the voltage-power conversion efficiency characteristic of the main rectification circuit 31 takes a peak value. To realize such a distribution state, β is set at 0.25, for example.

With the above setting and feedback control, the output voltage of the main rectification circuit 31 is located on the maximum conversion efficiency curve (curve-1) shown in FIG. 2. That is, since the input impedance of the error amplifier 42 is sufficiently high, an open-circuit voltage appears at the output of the sub-rectification circuit 32. At this time, since the output power of the sub-rectification circuit 32 is equal to 0, the characteristic of the open-circuit voltage curve (curve-2) shown in FIG. 2 is obtained. At this time, the input power of the main rectification circuit 31 is equal to (1−β) times input power that is received from the antenna 1 and the conversion efficiency of the main rectification circuit 31 takes a value on the maximum conversion efficiency curve (curve-1) which is obtained by shifting the open-circuit voltage curve (curve-2) rightward in FIG. 2. This corresponds to a peak value of the voltage-power conversion efficiency characteristic of the main rectification circuit 31 shown in FIGS. 4A-4C.

In FIG. 4A, the open-circuit voltage of the sub-rectification circuit 32 is equal to about 0.5 V and at this voltage the power conversion efficiency of the main rectification circuit 31 takes a maximum value of about 52%. In FIG. 4B, the open-circuit voltage of the sub-rectification circuit 32 is equal to about 0.7 V and at this voltage the power conversion efficiency of the main rectification circuit 31 takes a maximum value of about 61%. In FIG. 4C, the open-circuit voltage of the sub-rectification circuit 32 is equal to about 1.5 V and at this voltage the power conversion efficiency of the main rectification circuit 31 takes a maximum value of about 70%.

From another point of view, the DC-DC converter 4 performs a feedback control for equalizing the output voltages of the main rectification circuit 31 and the sub-rectification circuit 32. This control makes it possible to maximize the power conversion efficiency of the main rectification circuit 31.

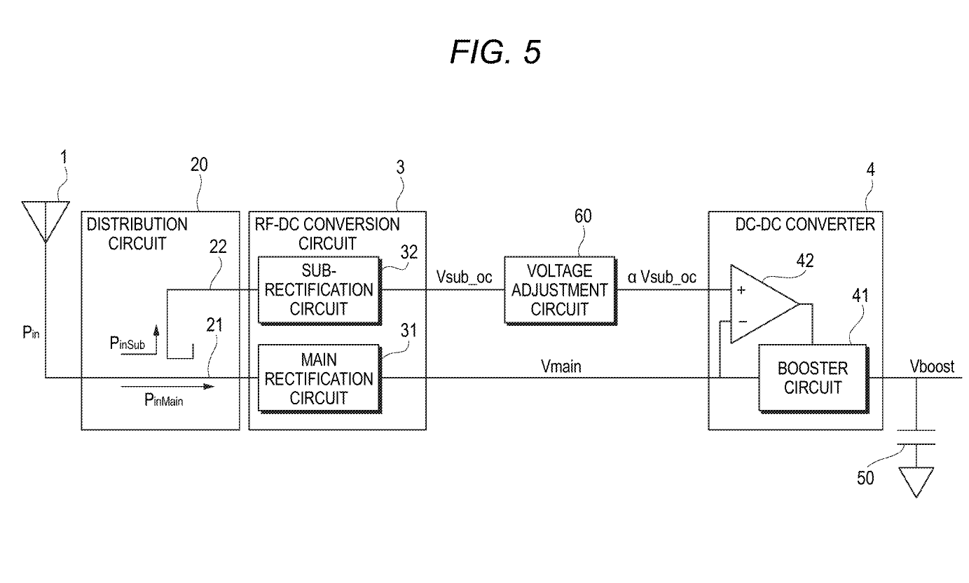

FIG. 5 is a block diagram of part of an energy harvest terminal 100 according to another embodiment. In the energy harvest terminal 100 according to this embodiment is different from the energy harvest terminal 100 according to the first embodiment shown in FIG. 3 in that a voltage adjustment circuit 60 is added and the constants of the distribution circuit 20 are changed.

The voltage adjustment circuit 60 is provided between the sub-rectification circuit 32 and the DC-DC converter 4 and generates a voltage that is proportional to an output open-circuit voltage of the sub-rectification circuit 32. That is, the voltage adjustment circuit 60 generates a voltage αV_{sub_oc} when the sub-rectification circuit 32 outputs an open-circuit voltage V_{sub_oc}, where α has a value that is larger than 1. The DC-DC converter 4 performs a feedback control for equalizing the output voltages of the main rectification circuit 31 and the voltage adjustment circuit 60.

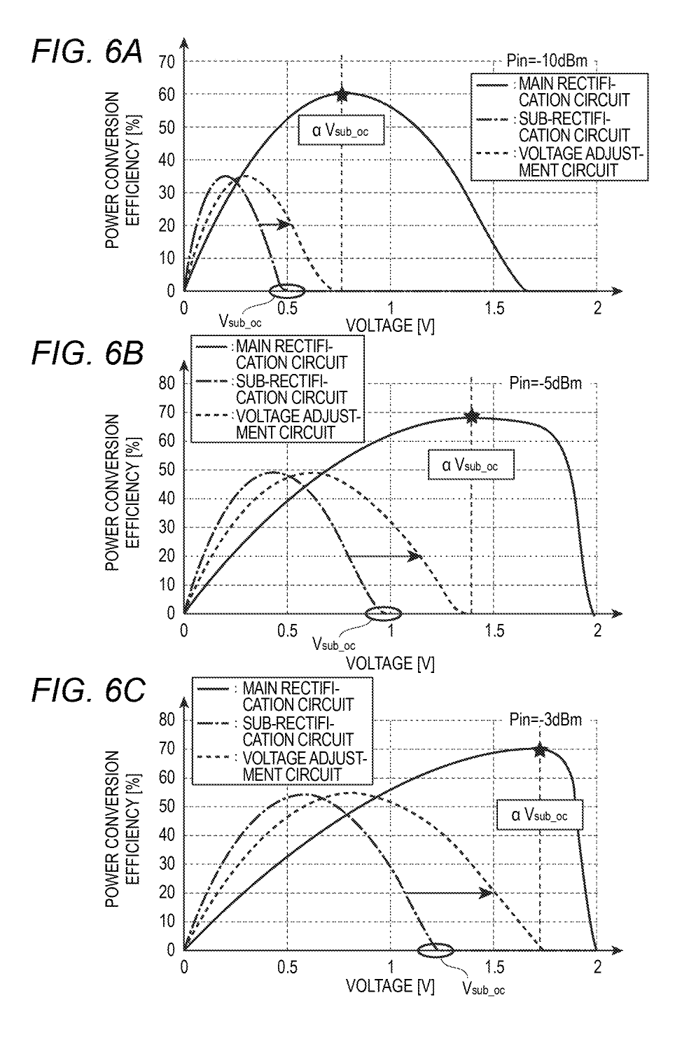

FIGS. 6A-6C are graphs showing voltage-power conversion efficiency characteristics (i.e., characteristics of the power conversion efficiency vs. the input voltage) of the main rectification circuit 31 and the sub-rectification circuit 32 shown in FIG. 5. FIGS. 4A-4C are graphs of cases that the input power Pᵢₙ is equal to −10 dBm, −5 dBm, and −3 dBm, respectively. The horizontal axis (x axis) corresponds to the input radio-frequency power and the vertical axis (y axis) represents the power conversion efficiency.

The characteristics of this embodiment are different from those shown in FIG. 4 in that the open-circuit voltage of the sub-rectification circuit 32 is made smaller than a voltage at which the voltage-power conversion efficiency characteristic of the main rectification circuit 31 takes a peak value. Thus, the power to be supplied to the sub-rectification circuit 32 can be made smaller than in case of the characteristics shown in FIGS. 4A-4C. In other words, the distribution circuit 20 is allowed to supply more power (i.e., most of the total power) to the main rectification circuit 31 than in the embodiment of FIG. 3. Since the power supplied from the distribution circuit 20 to the sub-rectification circuit 32 is suppressed, its open-circuit voltage is lowered. As indicated by an arrow in each of FIGS. 6A-6C, the voltage adjustment circuit 60 amplifies the thus-suppressed open-circuit voltage by a prescribed multiplier α. And the DC-DC converter 4 performs a feedback control for equalizing the output voltages of the voltage adjustment circuit 60 and the main rectification circuit 31. This control makes it possible to drive the energy harvest terminal 100 with high power conversion efficiency.

In FIG. 6A, the open-circuit voltage of the sub-rectification circuit 32 is equal to about 0.5 V and the voltage adjustment circuit 60 amplifies this open-circuit voltage to about 0.75 V, at which the power conversion efficiency of the main rectification circuit 31 takes a maximum value of about 60%. In FIG. 6B, the open-circuit voltage of the sub-rectification circuit 32 is equal to about 0.9 V and the voltage adjustment circuit 60 amplifies this open-circuit voltage to about 1.35 V, at which the power conversion efficiency of the main rectification circuit 31 takes a maximum value of about 70%. In FIG. 6C, the open-circuit voltage of the sub-rectification circuit 32 is equal to about 1.2 V and the voltage adjustment circuit 60 amplifies this open-circuit voltage to about 1.7 V, at which the power conversion efficiency of the main rectification circuit 31 takes a maximum value of about 70%.

The above control need not always be performed using the voltage adjustment circuit 60. It suffices that the energy harvest terminal 100 have a certain structure or function such as a device or a software control capable of generating a voltage αV_{sub_oc} that is proportional to an output open-circuit voltage of the sub-rectification circuit 32. The control being discussed can be realized by equalizing the thus-generated voltage to a voltage at which the power conversion efficiency of the main rectification circuit 31 takes a peak value.

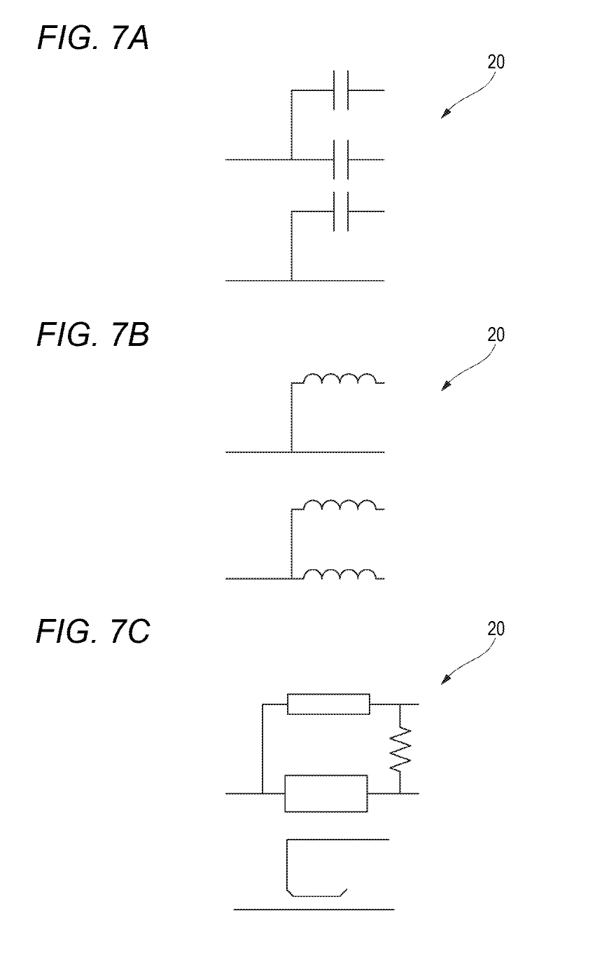

FIGS. 7A-7C show various examples of the distribution circuit 20. The example distribution circuits 20 shown in FIGS. 7A and 7B are ones using only lumped constant circuits, and the example distribution circuit 20 shown in FIG. 7C is one using distributed constant circuits. There are no particular limitations on the configuration, type, etc. of the distribution circuit 20.

In this disclosure, the RF-DC conversion circuit 3 consists of two systems, that is, the main rectification circuit 31 and the sub-rectification circuit 32, and the output voltage of the main rectification circuit 31 is optimized on the basis of an open-circuit voltage of the sub-rectification circuit 32. As a result, it is not necessary to monitor the output voltage of the main rectification circuit 31. Furthermore, since the power supplied to the sub-rectification circuit 32 is lower than that supplied to the main rectification circuit 31, the power conversion efficiency of the RF-DC conversion circuit 3 can be optimized by a simple, low-loss configuration. As a result, an energy harvest terminal that is superior in power conversion efficiency can be realized.

Although the energy harvest terminals according to the embodiments of the disclosure have been described above with reference to the drawings, it goes without saying that the concept of the disclosure is not limited to those examples. It is apparent that those skilled in the art would conceive various changes, modifications, replacements, additions, deletions, or equivalents within the confines of the claims. And they should naturally be construed as being included in the technical scope of the disclosure.

The disclosure contributes to highly efficient use of radio wave power by energy harvest terminals and hence accelerates use of energy harvest terminals further.

What is claimed is:

1. An energy harvest terminal comprising:
a distribution circuit that distributes input radio wave power to at least two branch paths;
a main rectification circuit that converts first radio wave power supplied to one of the at least two branch paths from the distribution circuit into DC output power;
a DC-DC converter that performs voltage conversion on the DC output power of the main rectification circuit;
a sub-rectification circuit that converts second radio wave power supplied to another of the at least two branch paths from the distribution circuit into DC output power; and
an electricity storage device connected to an output of the DC-DC converter,
wherein the DC-DC converter performs a feedback control for equalizing an output voltage of the main rectification circuit and an output voltage of the sub-rectification circuit.

2. The energy harvest terminal according to claim 1, wherein the distribution circuit distributes the input radio wave power to the at least two branch paths so as to equalize an output open-circuit voltage of the DC output power of the sub-rectification circuit with a voltage at which a voltage-power conversion efficiency characteristic of the main rectification circuit takes a peak value.

3. The energy harvest terminal according to claim 1, further comprising:
a voltage controller that generates a voltage that is proportional to an output open-circuit voltage of the DC output power of the sub-rectification circuit, and equalizes the generated voltage equal with a voltage at which a voltage-power conversion efficiency characteristic of the main rectification circuit takes a peak value.

4. The energy harvest terminal according to claim 3, wherein the voltage controller has a voltage adjustment circuit provided between the sub-rectification circuit and the DC-DC converter and generates the voltage that is proportional to the output open-circuit voltage of the sub-rectification circuit; and
wherein the DC-DC converter performs a feedback control for equalizing the output voltage of the main rectification circuit and an output voltage of the voltage adjustment circuit.
